(19) United States
(12) Patent Application Publication
(10) Pub. No.: US 2009/0287510 A1
(43) Pub. Date: Nov. 19, 2009

(54) Methods and products for providing incentive compatible mortgage loans

(75) Inventors: Jeffrey Lange, New York, NY (US); Jeffrey Lewis, New York, NY (US)

Correspondence Address: EDWARDS ANGELL PALMER & DODGE LLP, P.O. BOX 55874, BOSTON, MA, 02205, US

(73) Assignee: Guggenheim Partners, LLC, New York, NY (US)

(21) Appl. No.: 12/214,927

(22) Filed: Jun. 24, 2008

Related U.S. Application Data
(60) Provisional application No. 61/125,875, filed on Apr. 28, 2008.

(51) Int. Cl. G06Q 40/00

(52) U.S. Cl. 705/4; 705/38; 705/35

(57) ABSTRACT

A method for efficient first mortgage loans including the steps of identifying suitable borrowers for a marginally priced mortgage loan, determining an aggregate asset value of property owned by the suitable borrowers, determining a capital structure of the marginally priced mortgage loan for the respective property as between debt and equity, tranching the debt capital structure into a plurality of debt tranches, wherein lowest loan to value tranches have seniority over higher loan to value tranches, assigning each tranche an interest rate based upon a plurality of criteria including probability of default, correlation of default, and credit market conditions, creating a structured note which provides legal rights for each such tranche in a bankruptcy remote issuance entity and securitization or sale of such structured notes to investors.

### CROSS-REFERENCE TO RELATED APPLICATION

This application is related to co-pending U.S. patent application Ser. No. 11/653,451, filed Jan. 16, 2007 and U.S. Provisional Patent Application No. 61/125,875, filed on Apr. 28, 2008, which are incorporated herein by reference.

### FIELD OF THE INVENTION

Reverse mortgages are types of first mortgage loans which are non-recourse loans available to borrowers aged 62 and over. The loans are first mortgages against owner occupied residential property and are due generally upon either the death of the borrower, a lack of continuous owner occupation of the home, or upon default. Proceeds of the home are the sole source of funds for repayment.

The present disclosure provides novel methods, systems and products for providing more efficient first mortgage mortgage loans to borrowers This disclosure provides means generally applicable to all first mortgage loans, with particular application to reverse mortgage loans.

### BACKGROUND OF THE INVENTION

As the portion of the population in the United States aged 65 and older is expected to double to 70 million in the year 2030, there is a growing demographic need to provide funded and tax efficient means for the aging population to access their savings in the form of home equity. Current estimates of unencumbered home equity held by persons in the United States aged 65 and over range from 1 trillion to 2 trillion dollars. Such wealth is held in illiquid form not amenable to easy conversion into an efficient lifecycle and consumption plan.

A product that has emerged which attempts to convert the vast holdings of older Americans into liquid annuity cashflows is the reverse mortgage (RM). An RM is a non-recourse loan to an individual who owns substantial unencumbered home equity. The loan is provided to the individual against a first mortgage lien on the individual's home. The individual RM borrower can receive loan proceeds in either a lump sum payment, annuity payments for a certain period or for life, or in the form of discretionary payments similar to those that can be obtained with a home equity line of credit (HELOC). All principal and interest payments are due upon the death of the homeowner (or the last surviving homeowner, if applicable and if both homeowners are borrowers under the RM). The individual receives all RM proceeds free of tax. Upon death, the individual's estate receives a tax deduction for interest paid on the RM.

Currently, Federal Housing Administration (FHA), through the Housing and Urban Development agency (HUD), guarantees lenders providing the HUD Home Equity Conversion Mortgage (HECM) against default. These loans are available for homes which have appraised values less than $362,700, and less than this limit in areas with lower average home prices. A market for loans which are non-conforming to the government standards has emerged, typically for borrowers with home values which generally exceed the HECM limits (the “non-conforming” or “jumbo” market).

FIG. 1 shows a chart (year v. amount) illustrating growth in RM loans originated through the FHA Home Equity Conversion (HECM) program. As can be seen in FIG. 1, RM origination has grown steadily from 2000 to 2006, albeit from a very low foundation.

A number of disadvantages currently inhibit the growth of RM originations and their efficient lifecycle use by individuals. First, the conventional RM is very risky to the lender since the lender bears substantial longevity and real estate value risk. The lender may not be able to recover all principal and interest due upon the death of the borrower because the RM, unlike conventional mortgage products, is non-recourse. For example, if the individual lives well beyond life expectancy calculated when the RM loan was originated and/or if home values do not keep appreciating at a reasonably high rate. Thus, the loan rate and other fees charged the borrower on existing RM products are very high and have impeded substantial growth. A need therefore exists for a new RM product which a lender an issue at a lower cost to the borrower which, at the same time, addresses the economic risks to the lender in offering the RM at lower cost.

Second, traditional RM products, such as the HECM and existing jumbo products deliver proceeds to the borrower based upon the borrowers chronological age and standard mortality tables (such as the CDC decennial tables in the case of HECM's). Thus, a healthy 70 year will receive the same interest rate and upfront loan proceeds as a 70 year old who has a much shorter life expectancy due to illness and who therefore should receive greater proceeds that would be provided to a chronologically older borrower.

Third, current reverse mortgage products on the market often waive origination fees or closing costs or both if the borrower fully draws the proceeds to the approved mortgage limit, which is a function of appraised value and the age of the borrower. This is suboptimal in that the borrower will often not have use for all of the proceeds drawn and will invest these proceeds at a lower interest rate than the loan rate (“negative rate spread”). It also results in a loan which is much less valuable to investors as investors pay for loans based upon the possibility of future draws.

Fourth, reverse mortgage borrowers are charged interest rates based upon the full or maximum utilization of their principal limit. Under current state of the art loans, a borrower who owns a house worth $400,000 and is aged 70 might receive a principal limit of $200,000. While the borrower may only desire to draw, for example, $50,000 of this available credit line, the interest rate charged reflects that the borrower has the option to draw the entire line. Therefore, the interest rate must reflect the option for higher line usage and therefore a higher loan-to-value ratio (LTV) and is higher than the rate the buyer should be charged if he could make a binding commitment not to draw the entire line, i.e., each marginal portion of the loan proceeds drawn are separate and distinct segments or loan tranches. The present disclosure provides systems and methods and a loan product whereby the borrower's can receive a lower rate of interest on loan tranches which have lower LTV—thereby providing more efficient use of the credit line which (a) does not encourage overdrawing and (b) is marginally priced and (c) does not provide the borrower an option (the option to draw the whole line) in exchange for a much higher overall or average rate.

First mortgage loans in general, of which reverse mortgage loans are a subset, also are currently provided in an inefficient manner. In a typical first mortgage loan, the borrower receives a mortgage limit expressed as a LTV and an interest rate. For example, the borrower might get a 30 year fixed mortgage at 80% of the home's appraised value at a rate of 7%. Similarly, in a reverse mortgage transaction, a reverse mortgage borrower aged 70, might be able to receive proceeds of 40% of the home's appraised value at an interest rate of 8% which varies with 3 month LIBOR. In both first mortgage loan transactions, the loans receive “average cost” pricing, meaning that the entire loan is priced against the maximum LTV which the market typically affords for such a loan.

In the traditional first mortgage market, the LTV might be anywhere from 80-100% or more. In the reverse mortgage market, the LTV (which is called the “principal limit factor”) is based upon discounting back the home's future value at the borrower's expected age of death at the loan rate (and assuming some rate of home appreciation such as 4% in the case of HECM loans). In both these first mortgage loan cases, the home's capital structure comprised a level of debt up to the LTV limit (whether fully drawn at a particular time or not) and the homeowner's equity (e.g., of the LTV is 80%, the homeowner's equity is 20%). A homeowner can later take a second or third mortgage which is subordinate to the first mortgage but which is not part of the original first mortgage transaction. Furthermore, there is generally no large set of available options open to a first mortgage borrower whereby very senior and highly creditworthy marginal dollars borrowed—those corresponding to the lowest marginal LTV on indebtedness—bear lower interest rates than less senior and less creditworthy dollars borrowed.

A problem with the capital structure resulting from the first mortgage loans known in the art—both “forward” and reverse first mortgages—is that, contrary to modem financial securitization techniques, all parts of the debt capital structure receive the same loan terms. In particular, notwithstanding the fact that dollars borrowed at lower LTV's have lower risk to the lender, these dollars are borrowed at the same loan rate as dollars borrowed at higher LTV's, i.e., the interest rate on the loan is not priced to the marginal LTV.

### SUMMARY OF THE INVENTION

A need is recognized for first mortgage loans (i.e., traditional first mortgage loans and reverse mortgage loans), which provide multiple tranches of debt based upon LTV, where lower LTV tranches have lower interest rates than do higher LTV tranches, and where the lower LTV tranches are senior to the higher LTV tranches.

It is therefore an aim of the present disclosure to provide first mortgage loans in which (1) an individual can create more than one debt tranche on a loan which would otherwise be a first mortgage loan of a single tranche; (2) where tranches at lower LTV's are senior to those at higher LTV's; and (3) where the lower LTV tranches have interest rates lower than those of the higher LTV tranches.

It is an additional aim of the present disclosure to provide a reverse mortgage loan in which a borrower may (1) create more than one debt tranche on a loan, which would otherwise be a first mortgage loan of a single tranche; (2) where tranches at lower LTV's are senior to those at higher LTV's; and (3) where the lower LTV tranches have interest rates lower than those of the higher LTV tranches.

It is an additional aim of the present disclosure to provide a reverse mortgage loan which provides the lender the right to purchase a lender owned life insurance policy on the life or lives of the borrowers whereby borrowers who qualify for life insurance receive a better reverse mortgage loan in terms of a lower -rate or more proceeds or both than if they did not qualify or apply for the life insurance.

It is an additional aim of the present disclosure to provide a reverse mortgage loan which provides the lender the right to purchase a lender owned life insurance policy on the life or lives of the borrowers whereby borrowers who do not qualify for life insurance receive a better reverse mortgage loan in terms of a lower rate or more proceeds or both than if they did not apply for the life insurance.

The present disclosure provides methods, systems and products to solve the following problems in first mortgage loans found in the current art:

(1) Current RM products are too costly due to borrower moral hazard and lender risk;

(2) Current first mortgage products do not provide the borrower with the opportunity to conveniently provide marginal pricing on dollars borrowed as a function of LTV;

(3) Current RM products do not provide for better loans terms by providing for the possibility of lender owned life insurance;

(4) Current RM products do not provide for better loan terms by allowing the borrower or borrowers to apply for life insurance to determine the life expectancy of the borrower; and

(5) Current RM products are too risky and costly for lenders due to lack of additional collateral support provided by lender owned life insurance and marginal pricing on dollars borrowed as a function of LTV.

A need is recognized for a new RM product which is less costly to the borrower. Another need is recognized to reduce the overall borrowing cost to the borrower through reduction of RM loan risk to the lender and through reduction of origination costs. Still another need is recognized to reduce risk to the lender by having the lender underwrite lender owned life insurance on one or more RM borrowers.

A need is recognized for a mortgage loan product which can supplant traditional first mortgage loans by allowing the borrower to create marginal loan terms along the continuum of risk as measured by LTV, wherein lower, senior LTV borrowed dollars, bear, in a preferred embodiment, lower interest rates than higher, subordinate LTV borrowed dollars.

A need is recognized for an incentive compatible mechanism to elicit accurate information regarding the life-expectancy of a reverse mortgage borrower whereby such information is elicited by allowing the borrower to apply for a lender owned life insurance policy.

According to one embodiment of a new mortgage loan described here, a method for a new marginal price mortgage loan (MPML) includes the steps of:

(1) identifying the borrower for the MPML using a plurality of criteria;

(2) creating a capital structure comprising debt and equity for the borrower's home, wherein the debt portion comprises at least one tranche and the equity portion at least one tranche;

(3) assigning seniority levels to the debt tranches so that lower LTV tranches are more senior creditor claims than the higher LTV tranches; and

(4) determining a marginal price of credit for each tranche of debt using a plurality of means.

According to another embodiment of a new reverse mortgage loan system and/or product for a new marginal price reverse mortgage loan (MPRML) includes a computer operatively configured to perform the steps of: determining a candidate for the purchase of the MPRML based on a plurality of criteria; determining an advance rate if the borrower obtains life insurance based upon the borrower's age, home appraisal value, cost of insurance and other factors; determining the advance rate if the borrower does not obtain life insurance; based upon the borrowers age, expected lifespan, home appraisal value, and other factors; and after determining the advance rate, providing marginal pricing by creating tranches of the debt advance pursuant to the MPMR steps. The system may further have the lender of the MPRML purchase life insurance upon the life (or lives) of the borrower or borrowers from a plurality of carriers whereby such life insurance may be (a) general account universal life insurance (b) variable universal life insurance (c) term life insurance or (d) other types of life insurance such as whole life insurance where such borrower or borrowers are able to qualify for life insurance. The system may also provide the borrower or borrowers with the ability to apply for a policy of lender owned life insurance.

Another embodiment of the subject disclosure is directed to a method for efficient first mortgage loans including the steps of identifying suitable borrowers for a marginally priced mortgage loan, determining an aggregate asset value of property owned by the suitable borrowers, determining a capital structure of the marginally priced mortgage loan for the respective property as between debt and equity, tranching the debt capital structure into a plurality of debt tranches, wherein lowest loan to value tranches have seniority over higher loan to value tranches, assigning each tranche an interest rate based upon a plurality of criteria including probability of default, correlation of default, and credit market conditions, creating a structured note which provides legal rights for each such tranche in a bankruptcy remote issuance entity and securitization or sale of such structured notes to investors.

Still another embodiment is directed to a method for efficient marginally priced reverse mortgage loans including the steps of identifying suitable borrowers for a marginally priced reverse mortgage loan on a mortgaged property, determining an aggregate asset value of the mortgaged property, determining a life expectancy of the borrower or borrowers of the marginally priced reverse mortgage loan, obtaining consent of the borrower or borrowers for a lender of the marginally priced reverse mortgage loan to own life insurance on a life or lives of the borrower or borrowers, respectively, determining through life insurance underwriting whether the borrower or borrowers can be issued a life insurance policy, providing the borrowers who can obtain life insurance better loan terms, providing the borrowers who can not obtain life insurance at the given rating class loan terms that are better than if the borrower did not consent to and apply for life insurance, determining a principal limit factor for the marginally priced reverse mortgage loan, which defines a debt portion of a capital structure, determining the capital structure of the mortgaged property as between debt and equity, tranching a debt portion of the capital structure into a plurality of debt tranches, wherein a lowest loan to value tranches has seniority over higher loan to value tranches, assigning each tranche an interest rate based upon a plurality of criteria selected from the group consisting of probability of default, correlation of default, credit market conditions and combinations thereof, creating a structured note which provides legal rights for each such tranche in a bankruptcy remote issuance entity, and securitization or sale of the structured notes to investors.

It should be appreciated that the present invention can be implemented and utilized in numerous ways, including without limitation as a process, an apparatus, a system, a device, a method for applications now known and later developed or a computer readable medium. These and other unique features of the system disclosed herein will become more readily apparent from the following description and the accompanying drawings.

### BRIEF DESCRIPTION OF THE DRAWINGS

So that those having ordinary skill in the art to which the disclosed system appertains will more readily understand how to make and use the same, reference may be had to the drawings as follows.

FIG. 1 is a chart illustrating growth in RM loans originated through the FHA Home Equity Conversion (HECM) program.

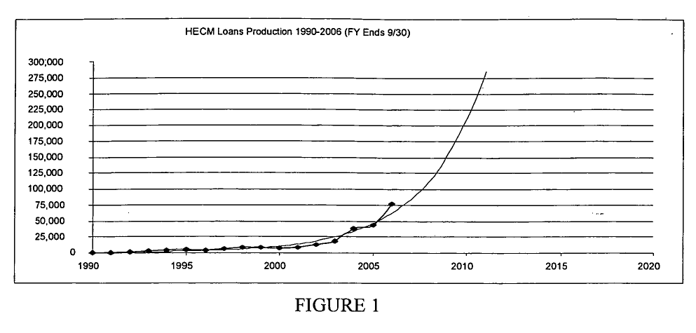

FIG. 2, there is shown a block diagram of an environment with a mortgage pricing system in accordance with the subject technology.

FIG. 3 is a flowchart representing a method for providing a marginally priced mortgage loan in accordance with the subject technology.

FIG. 4 is a schematic representation of a structure of a Collateralized Home Mortgage Obligation or CHMO in accordance with the subject technology.

FIG. 5 is a flowchart representing a method for the management of a marginally priced reverse mortgage loan or MPRML in accordance with the subject technology.

### DETAILED DESCRIPTION

The present invention overcomes many of the prior art problems associated with mortgage loans. These mortgage loans are intended to provide benefits over current first mortgage loans—both in the traditional mortgage market and in the growing reverse mortgage market. The advantages, and other features of the methods and systems disclosed herein, will become more readily apparent to those having ordinary skill in the art from the following detailed description of certain preferred embodiments taken in conjunction with the drawings which set forth representative embodiments of the present invention.

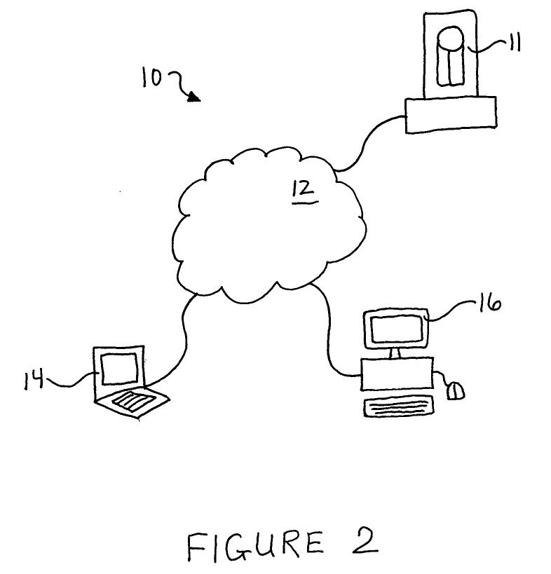

Referring now to the FIG. 2, there is shown a block diagram of an environment 10 with a mortgage pricing system embodying and implementing the methodology of the present disclosure. The mortgage pricing system connects users (e.g., mortgagors, mortgagees, life insurance providers and the like). The mortgage pricing system is user-interactive and may be self-contained so that users need not leave venture to another address within a distributed computing network to access various information. The following discussion describes the structure of such an environment 10 but further discussion of the applications programs and data that embody the methodology of the present invention is described elsewhere herein.

The environment 10 includes one or more servers 11 which communicate with a distributed computer network 12 via communication channels, whether wired or wireless, as is well known to those of ordinary skill in the pertinent art. In a preferred embodiment, the distributed computer network 12 is the Internet. For simplicity, one server 11 is shown. The server 11 hosts multiple Web sites and houses multiple databases necessary for the proper operation of the mortgage pricing system in accordance with the subject invention.

The server 11 is any of a number of servers known to those skilled in the art that are intended to be operably connected to a network so as to operably link to a plurality of clients 14, 16 via the distributed computer network 12. The plurality of computers or clients 14, 16 are desktop computers, laptop computers, personal digital assistants, cellular telephones and the like. The clients 14, 16 allow users to access information on the server 11. For simplicity, only two clients 14, 16 are shown. The clients 14, 16 have storage and computing capabilities along with displays and input devices as would be appreciated by those of ordinary skill in the pertinent art.

The flow charts herein illustrate the structure or the logic of the present technology, possibly as embodied in computer program software for execution on a computer or network. Those skilled in the art will appreciate that the flow charts illustrate the structures of the computer program code elements, including logic circuits on an integrated circuit, that function according to the present technology. As such, the present invention may be practiced by a machine component that renders the program code elements in a form that instructs a digital processing apparatus (e.g., computer) to perform a sequence of function steps corresponding to those shown in the flow charts or claims.

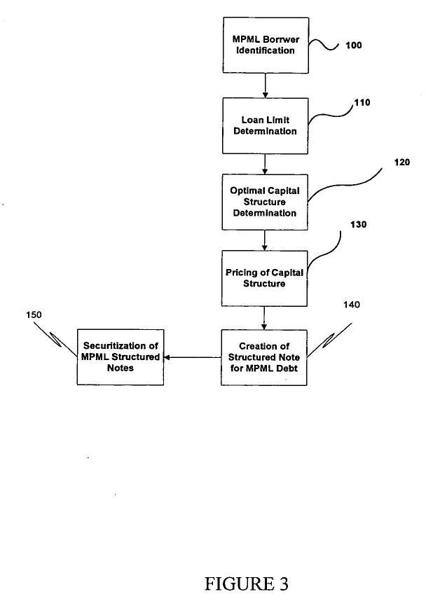

Referring now to FIG. 3, there is illustrated a flowchart depicting a process or method for creation of the Marginally Price Mortgage Loan (MPML) product. At step 100, the method identifies suitable borrowers. Suitable purchasers are those that might be of a certain age status, and have unencumbered home equity of a certain threshold amount. Additionally, and in a preferred embodiment, the state in which the MPML borrower may be an important fact in determining the terms on which a MPML may be offered.

At step 110, the method determines the maximum amount of debt that can be supported by the home, e.g., the loan limit. In the case of an MPML, the loan limit will be a function of, without limitation, the home's value, the credit score (FICO) of the borrower, the borrower's age, health and insurability, and other factors.

At step 120, the method determines the optimal capital structure for home based upon a plurality of factors. In a preferred embodiment, one such factor is a comparison of the total loan cost that the borrow can achieve by subordinating greater portions of home equity to the total amount of debt on the home, and, in turn, in a preferred embodiment, subordinating more risky portions of the debt which attach at higher LTV's to those portions at lower LTV's. The Weighted Average Cost of Debt Capital (WACDC) is the sum-product of the amount of debt at a given LTV multiplied by its associated market interest rate.

Multiple LTV tranches can be created on a single home. In one example, the method has 3 debt tranches and one equity tranche from step 120, an equity tranche of 25% of the appraised home value, and with 80% of asset value which is debt, there are 3 debt tranches, one from 0 to 25% LTV, one from 25% to 50% LTV, and one from 50% to 75% LTV.

The Weighted Average Cost of Capital (WACC) adds to the cost of equity capita. The WACDC and WACC are equal to:

$$WACDC = \frac{{\sum }_{i = 1}^{n} {w}_{i} {y}_{i}}{{\sum }_{i = 1}^{n} {w}_{i}}$$

$$WACC = WACDC + {w}_{e} {y}_{e}$$

where the subscripted w's are the portion of the capital structure and the subscripted y is the required interest rate (return on equity for yₑ) for each respective portion of the capital structure. Assume, for example, that y₁, the lowest LTV tranche, has an interest rate of LIBOR+50 basis points. Assume y₂, which attached from LTV 25% to 50% has an interest rate of LIBOR+80, and assume that y₃, which attached from 50% to 75% has an interest rate of LIBOR+150. The WACDC is therefore equal to LIBOR+93.33 basis points. This average cost of debt is much lower than the marginal cost of debt on the highest LTV tranche (LIBOR+150), which is typically offered to borrowers on their entire loan balance using first mortgage loans known in the art.

Referring still to FIG. 3, step 130, the method optimizes capital structure determination. In other words, the method will result in a capital structure which minimizes the WACDC to the borrower. Investors in each tranche, who are the lenders to the borrower, will offer interest rates on each tranche to maximize the risk adjusted return of holding the debt. One such measure, in a preferred embodiment, would be to set the LTV attachment point, the number of such tranches, and the interest rate on each tranche, so as to maximize the expected return on the portfolio of such tranches divided by the portfolio standard deviation of the return on the debt, where the covariances between the returns on each tranche would need to be input or assumed. In addition, estimated default rates would need to be input, or assumed, to make such a risk adjusted return calculation in a preferred embodiment.

At step 140, the method creates a structured note or debt obligation after the debt and equity capital structure has been determined. In a preferred embodiment, a traditional first mortgage loan which would provide the lender seniority over the entire debt on the home and, as is common in the art, pricing at a single rate is inadequate to provide the marginally priced mortgage loan of FIG. 3. In its place, in a preferred embodiment, is a new structure which can be termed a Collateralized Home Mortgage Obligation or CHMO.

A CHMO, in a preferred embodiment, provides for varying levels of seniority/subordination for lenders and the ability of lenders to price discriminate based upon their seniority. In a preferred embodiment, the entire debt on the home can be transferred to a bankruptcy remote special purpose entity (SPE) which then issues the tranches of different debt securities to lenders based upon their seniority.

At step 150, the method creates a structured note to achieve the goals of the CHMO, as described herein. Once the different tranches of the CHMO of been created, the different traches can then be sold off to investors in perhaps another securitization.

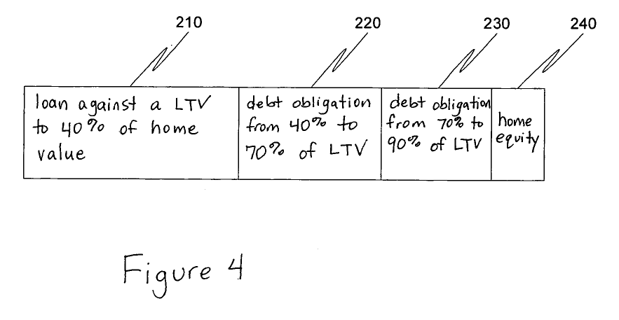

Referring now to FIG. 4, there is a schematic which describes what the tranched debt capital structure of a CHMO 200 is in a preferred embodiment depending upon, without limitation, the home's value, how much equity is subordinated to the entire home debt, the age of the insured, a cost of debt capital in the capitol markets, and other factors.

For example, the CHMO 200 includes a debt tranche portion 210 that provides a loan against a LTV to 40% of home value. The debt on the debt tranche portion 210 of the CHMO 200 could be current pay, negatively amortizing, have a lower rate for a number of years, be fixed or floating and the like. Because the debt tranche portion 210 is senior in the debt capital structure and is unlikely to default based upon either the borrower's financial condition or residential real estate prices, the marginal interest rate borne by the debt tranche portion 210 is much lower than the average interest rate that would be borne on the entire debt capital structure on the home. For example, in a preferred embodiment and subject to credit market conditions, the debt corresponding to the debt tranche portion 210 might bear an interest rate of LIBOR+50 basis points assuming a floating rate obligation as an example.

Still referring to FIG. 4, the CHMO 200 also includes a debt obligation portion 220 from 40% LTV to 70% LTV, an obligation less senior to the debt tranche portion 210 (i.e., subordinated to the debt tranche portion 210). In a exemplary preferred embodiment, the debt obligation portion 220 might carry a interest rate of LIBOR+100 basis points.

The CHMO 200 may also include another debt obligation portion 230 spanning 70% to 90% of LTV, subordinate to the debt obligation portion 220 and therefore also subordinate to the debt tranche portion 210. This debt obligation portion 230 might bear an interest rate of LIBOR+175 basis points. The CHMO 200 may also include a home equity portion 240 equal to the remaining 10% of home value. The home equity portion 240 is subordinated to the entire debt structure represented by the debt obligations 210, 220, 230.

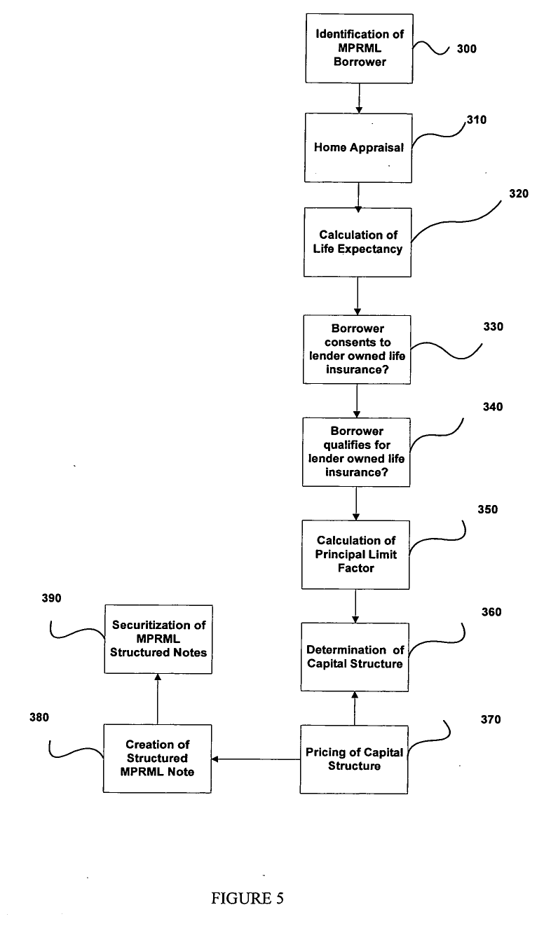

Referring now to FIG. 5, a flowchart representing a method for the management of a marginally priced reverse mortgage loan or MPRML in accordance with the subject technology is shown. The process or method of FIG. 5 creates, underwrites, structures and sells a MPRML.

At step 300, the method identifies suitable borrowers or purchasers. Suitable purchasers are those that might be of a certain age, insurable status, and have encumbered home equity of a certain threshold amount. For reverse mortgages (RM's) which conform to FHA or Fannie Mae guidelines (under, for example, the FHA HECM or Fannie Mae Homekeeper programs) borrowers must be at least 62 years of age. For RM's which need not conform to federal standards, a lower age may apply, though typically the MPRML will be offered to those aged 62 and older.

RM's typically require unencumbered home equity at the time of loan origination. However, it is also possible to refinance existing home debt and add the balance to the newly originated RM provided there is sufficient equity in the home. Additionally, the identification of likely MPRML borrowers may include the analysis of prospective borrowers' current portfolio holdings or potential holdings of risky assets, an analysis of their present and future tax liabilities, and their bequest motives for their heirs (i.e., an analysis of their utility function for leaving large amounts of wealth to heirs). The state in which the MPRML borrower may be an important fact in determining the terms on which a MPRML may be offered. Typically, in order for the lender to purchase life insurance, which offers sufficient collateral support to the lender, the borrower/insured should reside in a state in which the lender purchase of life insurance is not onerously regulated by that state's credit life insurance regulations.

For example, the following is an excerpt from the relevant California statute with the relevant portions underlined:
779.2. All life insurance and all disability insurance sold in connection with loans or other credit transactions shall be subject to the provisions of this article, except (a) such insurance sold in connection with a loan or other credit transaction of more than 10 years duration, and (b) such insurance where its issuance is an isolated transaction on the part of the insurer not related to an agreement or a plan or regular course of conduct for insuring debtors of the creditor. Nothing in this article shall be construed to relieve any person from compliance with any other applicable law of this state, including, but not limited to, Article 6.5 (commencing with Section 790), nor shall anything in this article be construed so as to alter, amend, or otherwise affect existing case law. For the purpose of this article: (1) “Credit life insurance” means insurance on the life of a debtor pursuant to or in connection with a specific loan or other credit transaction, exclusive of any such insurance procured at no expense to the debtor. Insurance shall be deemed procured at no expense to the debtor unless the cost of the credit transaction to the debtor varies depending on whether or not the insurance is procured.

Most U.S. states accept life insurance in connection with credit transactions based upon the duration of the loan (e.g., 10 or 15 years), where the insured does not pay for the policy, or where the loan is a first mortgage loan. Thus, for states with these exceptions, life insurance originated in connection with RM lending will not be subject to the statutes.

Referring still to FIG. 5, at steps 310 and 320 in the method, a determination of the MPRML loan limit occurs. The determination of the loan limit is based on a plurality of factors. The factors, without limitation, are selected from the following:
(1) Computing the expected lifespan for the borrower, borrowers, or other home occupants. Where more than one borrower is on the loan, the computation of the expected lifespan may be performed on a last to die basis, meaning the expected number of years until the last borrower on the MPRML has died;
(2) Determining the current value of the home to be provided as collateral under the MPRML. The determination of current home value can be accomplished by appraisal, comparable sales, purchase of research of econometric data, and other methods of home value estimation known in the art;
(3) Whether the loan proceeds of the BRM are to be received in the form of annuity cashflows for the lives of the borrowers, a lump sum payment, or as a line of credit providing for discretionary draws by the borrowers;
(4) The interest rate on the loan, whether fixed of floating, the spread to fixed to floating rates as a function of the credit risk of the loan and market conditions; and
(5) The cost of private mortgage insurance (PMI) if necessary or desirable.

As an example of the loan limit determination based on the following assumptions and calculations as shown below in Table 1:

TABLE 1

| Age of Male Homeowner and Spouse | 74 and 70, respectively |
|---|---|
| Home Value, Spot | $500,000 |
| Assumed RM Rate | 8% (approximately 3M |
| | LIBOR + 300 bps at current |
| | market rates), assumed constant |
| | through life expectancy |
| Life Expectancy | 17 year (for both homeowners) |
| Assumed Home Appreciation | 4% per annum (in line with |
| | Fannie Mae assumptions) |
| Assumed Assessed/Market Value Ratio | 70% |
| Forward Assessed Home Value | $973,950 at LE of 17 years |
| LTV | 100% of Spot Collateral Value |
| RM Proceeds | $263,228 |

In the above example, the loan limit of $263,228 is the amount that grows to the forward appreciated home value of $973,950 when compounded annually at the loan rate of 8% to the life expectancy of each borrower. Alternatively, a second to die lifespan longer than 17 years could have been used which would have resulted in a lower RM proceeds (principal limit factor). Different combinations of these principles, as is apparent to one skilled in the art upon review of the subject disclosure, will lead to different loan limits.

At step 320 of FIG. 5, the method computes the conditional life expectancy using the following quantities and notation:

q_{t,T}=the probability of death between time t and T, conditional upon survival to time t

p_{t,T}=the probability of survival between time t and T, conditional upon survival to time t

As is commonly used, if the period of death and survival is taken to be a calendar year, the shorthand, qₜ and pₜ will be used respectively, where the second subscript, T, is implicitly understood to be equal to t+1 year. So, for example, q₆₅ is the probability that a 65 year old of a given risk class (make, nonsmoker, select) dies in the next calendar year while p₆₅ is the probability that a 65 year old of a given risk class survives in the next year. For step 320 of FIG. 5, the first substep is to acquire the qₜ for the given risk class which are available, for example, from the 2001 VBT table below as Table 2 (the qₜ for a 65 year old male nonsmoker is shown in Table 2). Since mortality charges are proportional to qₜ, one may assume that the qₜ also represent the fair cost of insurance for an individual of age t in the given risk class.

TABLE 2
2001 VBT Mortality Rates for Male Nonsmokers Aged 65

| Age | Annual Mortality Rate |
|---|---|
| 66 | 0.25% |
| 67 | 0.41% |
| 68 | 0.58% |
| 69 | 0.77% |
| 70 | 0.96% |
| 71 | 1.15% |
| 72 | 1.34% |
| 73 | 1.52% |
| 74 | 1.72% |
| 75 | 2.06% |
| 76 | 2.45% |
| 77 | 2.92% |
| 78 | 3.46% |
| 79 | 4.12% |
| 80 | 4.90% |
| 81 | 5.59% |
| 82 | 6.28% |
| 83 | 7.00% |
| 84 | 7.86% |
| 85 | 8.93% |
| 86 | 10.00% |
| 87 | 11.21% |
| 88 | 12.54% |
| 89 | 13.98% |
| 90 | 15.37% |
| 91 | 18.32% |
| 92 | 19.71% |
| 93 | 21.16% |
| 94 | 22.70% |
| 95 | 24.30% |
| 96 | 25.73% |
| 97 | 27.25% |
| 98 | 28.86% |
| 99 | 30.56% |
| 100 | 32.35% |
| 101 | 34.26% |
| 102 | 36.27% |
| 103 | 38.41% |
| 104 | 40.66% |
| 105 | 43.02% |
| 106 | 45.52% |
| 107 | 48.16% |
| 108 | 50.95% |
| 109 | 53.91% |
| 110 | 57.03% |
| 111 | 60.34% |
| 112 | 63.84% |
| 113 | 67.54% |
| 114 | 71.46% |
| 115 | 75.60% |
| 116 | 79.99% |
| 117 | 84.63% |
| 118 | 89.54% |
| 119 | 94.73% |
| 120 | 100.00% |

As can be seen in Table 2, the mortality charges increase with age at an increasing rate. As is known to one skilled in the art, there are relationships between the annual probabilities of death and the survival probabilities as follows:

$${p}_{t , T} = {\prod }_{i = t}^{i = T} ( 1 - {q}_{i} )$$

That is, the probability of surviving from time t to T is the product of one minus the probability of dying in each year from t to T. For the above “hazard rates” derived from Table 2, the probability distribution for the death of a select 65 year old male nonsmoker (select in the sense that this individual qualifies for life insurance) is as shown in Table 3 below.

TABLE 3
2001 VBT Mortality Distribution for Male Nonsmokers Aged 65

| Age | Probability of Death |
|---|---|
| 66 | 0.25% |
| 67 | 0.41% |
| 68 | 0.58% |
| 69 | 0.76% |
| 70 | 0.94% |
| 71 | 1.12% |
| 72 | 1.28% |
| 73 | 1.44% |
| 74 | 1.60% |
| 75 | 1.88% |
| 76 | 2.20% |
| 77 | 2.55% |
| 78 | 2.94% |
| 79 | 3.38% |
| 80 | 3.86% |
| 81 | 4.18% |
| 82 | 4.44% |
| 83 | 4.63% |
| 84 | 4.84% |
| 85 | 5.06% |
| 86 | 5.17% |
| 87 | 5.21% |
| 88 | 5.18% |
| 89 | 5.05% |
| 90 | 4.77% |
| 91 | 4.81% |
| 92 | 4.23% |
| 93 | 3.65% |
| 94 | 3.08% |
| 95 | 2.55% |
| 96 | 2.05% |
| 97 | 1.61% |
| 98 | 1.24% |
| 99 | 0.93% |
| 100 | 0.69% |
| 101 | 0.49% |
| 102 | 0.34% |
| 103 | 0.23% |
| 104 | 0.15% |
| 105 | 0.09% |
| 106 | 0.06% |
| 107 | 0.03% |
| 108 | 0.02% |
| 109 | 0.01% |
| 110 | 0.00% |
| 111 | 0.00% |
| 112 | 0.00% |
| 113 | 0.00% |
| 114 | 0.00% |
| 115 | 0.00% |
| 116 | 0.00% |
| 117 | 0.00% |
| 118 | 0.00% |
| 119 | 0.00% |
| 120 | 0.00% |

Referring again to FIG. 5, step 330 is the procurement of consent from the MPRML borrower or borrowers for the lender to purchase life insurance on the respective lives of the MPRML borrowers. The lender has an insurable interest in the borrower or borrowers under a plurality of separate legal principles. First, as a lender, state statutes generally recognize a creditor's insurable interest in a debtor. Second, since the lender has entered into an agreement whereby the lender has the obligation to buy back the property upon the death of one or more individuals, the lender suffers a financial loss or obligation upon the death of such individuals. State statutes also recognize these set of circumstances as giving rise to an insurable interest.

Without regard to the legal foundation for insurable interest, the insured or insureds under a validly originated life insurance policy must consent to the issuance of such insurance. In a preferred embodiment, such consent will contain at least the following: (a) an acknowledgement by the insured of the purpose of the insurance; (b) an acknowledgement that the insured or insureds will not receive any benefits under the insurance policy; and (c) an acknowledgement that the procurement of such insurance may impair the ability of the insured or insureds to obtain life insurance in the future.

At step 340, the method provides for the actual selection and purchase of the life insurance on the lives of the MPRML borrowers who qualify for insurance at rates above a certain medical underwriting threshold. For example, all borrowers can be qualified based upon a standard—nonsmoker-Table D rating and above. In a preferred embodiment, such life insurance will have the following characteristics: (1) a fixed universal life insurance policy structure (“fixed UL”); (2) no-lapse guaranteed premiums; and (3) a return of premium rider. In other preferred embodiments, variable universal life insurance, term insurance, or other types of life insurance with different structures may be used.

Still at step 340 in FIG. 5, if the borrower qualifies for life insurance acceptable to the lender, the lender may purchase such life insurance to provide additional security for the reverse mortgage loan made to the borrower. Since the MPRML now has more security due to the life insurance collateral, the lender may increase the reverse mortgage loan proceeds or reduce the reverse mortgage loan rate or both in order to provide a loan more favorable to the borrower based upon the additional life insurance collateral.

If the borrower or borrowers do not qualify for life insurance (again above a certain medical underwriting threshold), the lender would have obtained valuable information regarding the borrower or borrowers life expectancy compared to the average life expectancy. In particular, a borrower that may not qualify for life insurance has been judged by the underwriting department of the insurance company to have a statistically shorter lifespan than a borrower who does qualify. Because such a non-qualifying borrower has a shorter lifespan, he or she may be entitled to greater loan proceeds based upon this underwriting information as shorter lifespans (or older borrowers) receive more proceeds in the reverse mortgage market.

In view of the above, a borrower who merely agrees to consent and apply for life insurance of the reverse mortgage product faces a classic “win-win” situation. If the borrower qualifies for life insurance, the terms of the loan improve, and if the borrower does not qualify, the terms of the loan also improve when compared to not going through the underwriting process. Importantly, to give borrowers the right inventive to reveal accurate health information to the life insurer, the lender, in a preferred embodiment, may offer better terms to the borrower if the borrower qualified for life insurance than if the borrower does not qualify, where both improved terms to the borrower who applies and goes through the life insurance underwriting process are better than for the borrower who does not apply at all.

For example using the data in Table 1, RM proceeds for the loan without applying for life insurance were equal to $263,228. If the borrower or borrowers successfully qualified for life insurance, then the borrower's proceeds may be increased 10% to $289,551. If however, the borrower does not qualify, the borrower's proceeds may be increased from the original $263,228 by 5% to $276,390.

Referring again to FIG. 5, at step 350, the method computes the final calculation of the amount of debt that can be supported by the home as a function of the previous steps, which may determined by a plurality of factors including the home value, the borrower(s) age, the borrower(s) sex, interest rates, and whether the borrower(s) qualify for life insurance.

Subsequent to determining the amount of debt in aggregate that can be supported under the MPRML, the method determines the optimal capital structure of the debt at step 360. The method tranches the debt into portions of higher and lower seniority whereby the number of such tranches, the respective LTC attachment points, and size are a function of the value of the home, the age of the borrower or borrowers, market interest rates, and other factors described above in connection with the capital structure determination a preferred MPML.

At step 370, the method prices the debt capital structure of the MPRML in a manner which reflects credit market conditions and which minimizes the WACDC to the borrower as described above. The method continues to replace the traditional first mortgage note reverse mortgage by a structured note containing subordination rules, structure, and interest rates for each tranche of the MPRML at step 380. At step 390, the respective tranches of the structured note may be sold to investors or further securitized.

A great advantage of the method of FIG. 5 is that each portion of the debt capital structure of the RM is marginally priced, i.e., bears an interest rate to its relative security, seniority, or probability of default. In traditional reverse mortgages, both HECM mortgages and proprietary non-conforming jumbo loans, the reverse mortgage interest rate is set to reflect the right of the borrower to draw down the entire credit line. Because the borrower has the right to draw under the known reverse mortgages to the entire principal limit factor, the loans must carry a higher interest rate to reflect this option. The method of FIG. 5 provides a product where the option to draw the entire line can be priced on the marginally drawn dollar, i.e., lower LTV drawn dollars receive lower interest rates than higher draws at higher LTV. The pricing of the option to draw has a number of benefits. First, the incentive for a borrower to overdraw and earn negative interest rate spread on dollars drawn is reduced since as the borrower draws more dollars he borrows at progressively higher interest rates. Second, the investors are likely to prefer a marginally priced set of debt obligations since the option to draw proceeds at higher LTV's can be efficiently priced. This efficiency is jointly captured by the borrower and the lender.

In the preceding specification, the present invention has been described with reference to specific exemplary embodiments thereof. Although many steps have been conveniently illustrated as described in a sequential manner, it will be appreciated that steps may be reordered or performed in parallel. It will further be evident that various modifications and changes may be made therewith without departing from the broader spirit and scope of the present invention as set forth in the claims that follow. The description and drawings are accordingly to be regarded in an illustrative rather than a restrictive sense.

What is claimed is:

1. A method for efficient marginally priced reverse mortgage loans comprising the steps of:
identifying suitable borrowers for a marginally priced reverse mortgage loan on a mortgaged property;
determining an aggregate asset value of the mortgaged property;
determining a life expectancy of the borrower or borrowers of the marginally priced reverse mortgage loan;
obtaining consent of the borrower or borrowers for a lender of the marginally priced reverse mortgage loan to own life insurance on a life or lives of the borrower or borrowers, respectively;
determining through life insurance underwriting whether the borrower or borrowers can be issued a life insurance policy;
providing the borrowers who can obtain life insurance better loan terms;
providing the borrowers who can not obtain life insurance at the given rating class loan terms that are better than if the borrower did not consent to and apply for life insurance;
determining a principal limit factor for the marginally priced reverse mortgage loan, which defines a debt portion of a capital structure;
determining the capital structure of the mortgaged property as between debt and equity;
tranching a debt portion of the capital structure into a plurality of debt tranches, wherein a lowest loan to value tranches has seniority over higher loan to value tranches;
assigning each tranche an interest rate based upon a plurality of criteria selected from the group consisting of probability of default, correlation of default, credit market conditions and combinations thereof;
creating a structured note which provides legal rights for each such tranche in a bankruptcy remote issuance entity; and
securitization or sale of the structured notes to investors.

2. A method for efficient first mortgage loans comprising the steps of:
identifying suitable borrowers for a marginally priced mortgage loan;
determining an aggregate asset value of property owned by the suitable borrowers;
determining a capital structure of the marginally priced mortgage loan for the respective property as between debt and equity;
tranching the debt capital structure into a plurality of debt tranches, wherein lowest loan to value tranches have seniority over higher loan to value tranches;
assigning each tranche an interest rate based upon a plurality of criteria including probability of default, correlation of default, and credit market conditions;
creating a structured note which provides legal rights for each such tranche in a bankruptcy remote issuance entity; and
securitization or sale of such structured notes to investors.

3. A collateralized home mortgage obligation for a home comprising:
a first debt tranche portion against a loan-to-value ratio (LTV) to 40% of home value;
a second debt tranche portion against 40% LTV to 70% LTV, wherein the second debt tranche portion is subordinated to the first debt tranche; and
a third debt portion spanning 70% to 90% of LTV, wherein the third debt tranche is subordinated to the second debt tranche.

4. A collateralized home mortgage obligation as recited in claim 3, wherein the first debt tranche portion is a type selected from the group consisting of current pay, negatively amortizing, a lower rate for a number of years, fixed, floating and combinations thereof.

5. A collateralized home mortgage obligation as recited in claim 3, wherein the first debt tranche portion bears an interest rate of LIBOR+50 basis points.

6. A collateralized home mortgage obligation as recited in claim 3, wherein the second debt tranche portion bears an interest rate of LIBOR+100 basis points.

7. A collateralized home mortgage obligation as recited in claim 3, wherein the third debt portion bears an interest rate of LIBOR+175 basis points.

8. A collateralized home mortgage obligation as recited in claim 3, further comprising a home equity portion.

9. A collateralized home mortgage obligation as recited in claim 8, wherein the home equity portion equals 10% of the home value and subordinated to the first, second and third debt portions.
